(19) United States
(12) Patent Application Publication
(10) Pub. No.: US 2016/0251525 A1
(43) Pub. Date: Sep. 1, 2016

(54) PERMANENT ANTI-FOG COATINGS AND DELIVERY DEVICES THEREOF, FOR DIRECT APPLICATION OF WET OR DRY TEMPORARY, SEMI-PERMANENT & PERMANENT ANTI-FOG COATINGS ON LENSES, SURFACES & MEDICAL DEVICES

(71) Applicant: SiO2 Nanotech, Phoenix, AZ (US)

(72) Inventors: Nicole Herbots, Tempe, AZ (US); Clarizza Watson, Gilbert, AZ (US); Eric J. Culbertson, Los Angeles, CA (US); Pierre Thilmany, Schaerbeek (BE); Mayuri Gupta, Vancouver, WA (US); Saloni Sinha, Phoenix, AZ (US); Abijith Krishnan, Scottsdale, AZ (US); Igor Pinheiro de Oliveiro Martins, Tagauatinga (BR); Nehal Gupta, Tempe, AZ (US); Karlin McLeod, Mesa, AZ (US)

(73) Assignee: SiO2 Nanotech, Phoenix, AZ (US)

(21) Appl. No.: 14/946,773

(22) Filed: Nov. 19, 2015

Related U.S. Application Data
(60) Provisional application No. 62/081,975, filed on Nov. 19, 2014.

(51) Int. Cl. C09D 7/12; C09D 105/00; C09D 101/02; B65D 83/00; C09D 101/08

(52) U.S. Cl. CPC C09D 7/1216; B65D 83/0005; C09D 101/08; C09D 101/02; C09D 105/00; C08K 3/22

(57) ABSTRACT

The invention consists of three parts made to work together to ensure safe, fast and effective deployment to the end users of lasting anti-fog coatings in wet or dry form. End users include but are not limited to surgeons and doctors in emergency and operating rooms, occupational hazards equipment goggles, visors and shields, defensive protective armors and high impact vision wear, high performance athletic equipment, and avionics surfaces. The three parts of the invention are the anti-fog coating materials composition, their methods of preparation, processing and drying in large, medium or small scale manufacturing, and a single unit delivery device with the coating materials to apply on any existing surface, lens, scope, tools or dials, as a wet or quickly drying coating.

### TECHNICAL FIELD

This application relates to the field of coatings that prevent fogging on solid surfaces without altering the characteristics of the covered surface. The coatings may be used on devices and equipment for sports and recreation, the medical field, military and industrial safety applications. Such devices and equipment include windows and mirrors of automobiles, motorcycles, boats, airplanes, and trains. In industrial and instrumentation application: protective windows, domes, and lenses of gauges, dials, meters. In medical applications: intraocular lenses, endoscopic/laparoscopic lenses, protective eyewear, contact lenses for visual correction, medical implants, surfaces, and medical and surgical tools.

### BACKGROUND

The problem of condensation with fogging: Hydrophobic versus hydrophilic surfaces.

Protective eyewear, glasses, sunglasses, swimming goggles, diving goggles, helmet visors, windshields, intraocular lenses, medical scopes, and high-precision instrumentation are just several applications where visual distortion due to fogging with condensation poses a problem.

Control of fogging due to condensation on polymer and glass surfaces has seen development, testing and patenting of solutions for a broad spectrum of optical, vision, visor, goggle and lens materials, including optical glasses, borosilicate glass, polycarbonates, tinted thin film coatings, and other polymers for athletic visor and vision-wear. These can require optimization of the robustness and resiliency to create permanent anti-fog coatings, and optimization of adhesion on polycarbonates and surfaces with difficult geometries such as very high curvature.

Therefore, anti-fog technologies and their applications have to be conceived and optimized by adapting to a broad range of specifications for use, use duration, etc., and require working directly with a variety of end users to create such adaptability.

End users for anti-fog technology include, but were not limited to: surgeons, professional athletes, recreational users, professional safety users, fire-workers, emergency personnel, biohazard handlers, medical and surgical personnel, and instrumentation dials and domes manufacturers.

Control of fogging should be tested using the specific conditions of condensation experienced by each group end users, such as body or outdoor temperatures, and water vapor pressures and various fluids present during use, such as bodily fluids, sweat, blood, skin oils and human tears or fluids produced from machinery.

U.S. patent application Ser. No. No. 13/674,307 (hereinafter '307 application) describes an emulsion that physically changes the surface topography so that condensation behavior can be controlled. The result in the '307 application is a hydrophilic surface that manipulates water droplets so that the water droplets form a thin translucent film on the hydrophilic surface. The '307 application describes a wet anti-fog technology, where the emulsion is applied when the surface requires an antifogging coating and should not be dried on the surface. When the emulsion of the '307 application is dried, the polymers come out of the solution and precipitate so that the coated surface is no longer optically transparent and fails to maintain optical quality. Specifically, the emulsion described in the '307 application is optimized for temporary application and for ease of application. The emulsion described in the '307 application was designed for medical applications, including but not limited to vitro-retinal surgery as well as endoscopic and laparoscopic procedures and surgeries. Thus the emulsion described in the '307 application does not permanently coat the surfaces with anti-fog technology. Accordingly, there is need for a dry permanent anti-fog technology that manipulates water so the water droplets form a thin translucent film on a surface rather than produce fogging on the surface while maintaining optical quality.

### SUMMARY

First, the invention consists of permanent anti-fog coatings, including but not limited to their materials components, composition, adaptive formulation and several methods of fabrication. The permanent anti-fog is referred to as “FogKnox™”. It includes but is not limited to very high quality optical transmission films that are distortion-free, and exhibit a very high degree of transparency. FogKnox™ includes but is not limited to dry, permanent and very highly uniform optical anti-fog coatings, which can be delivered in wet (fluid) or solid from. Both wet and solid form preserve and improve instantaneously visualization on edges of lenses, dials and surfaces and wide-angle lens. Only after drying is the anti-fog a permanent, non-removable solid film.

In a separate embodiment, the anti-fog coatings can be made removable for applications where lenses and devices on which they are applied need to be resurfaced, called KnoxFog™. The anti-fog coatings can also be made semi-permanent, so it can be scrubbed, thus removable by scrubbing, detergent washing and/or sonication, for medical applications, and are then called VitreOx™.

Second, the invention includes, for all above mentioned anti-fog coatings, their method of application in large scale, medium scale or small scale manufacturing, via several possible coating processes, adaptive compositions, adjustments of physical properties and surface preparation procedures, which are disclosed as the second part of the invention.

Third, all the above coatings can also be applied on existing, already manufactured optical devices, tools, dials, goggles, vials, bottles and scopes, via the third element of the invention, a specific delivery device and its cartridge of anti-fog coatings materials. The delivery device includes a coating delivery and element to allow for quick drying element attachment to the metered delivery automated mechanism to apply the coating in a few seconds, and let it dry within minutes.

### BRIEF DESCRIPTION OF FIGURES

FIG. 1—Three-Dimensional View of an embodiment of an invention application device: ClearEndoscope™ (Generated by SolidWorks™).

FIG. 2—Cross-section view of the device of FIG. 1.

FIG. 3—Cross-section view of the device of FIG. 1 showing Luer Lock port.

FIG. 4—Sketch showing design concept for ClearEndoscope with 3 functions.

FIG. 5—Cross-section view of a device embodiment showing Luer Lock port and the perforated plate.

FIG. 6—Condensation Mechanisms.

FIG. 7—Glass pane with 3 different areas.

FIG. 8—Thin Film Growth.

FIG. 9A 3LCAA Experimental Configuration; FIG. 9B Photograph Droplets; FIG. 9C Contact Angle; FIG. 9D Surface Energy Graph.

FIG. 10 Endoscope images.

FIG. 11A Endoscope images (control) and FIG. 11B VitreOx™ material.

### DETAILED DESCRIPTION

Applying device 100
Wall 110
open end 120
AFC end 130
dipping cup 140
transition 145
drying window 150
female luer lock port 160
syringe guide 170
perforated plate 180

Unless otherwise provided the temperatures at which the values were measured was 25 degrees C.

Superhydrophillic-surface wets just as if water were being coated.

A convenient and efficient method for eliminating the formation of fog on endoscope lenses is provided. The term “endoscope” as used herein means any device inserted into a body having a lens for viewing the interior of the body and viewing means located outside the body. The endoscopic image may be viewed with the eye, either directly or via television or video. The antifogging composition may be used on all types of endoscopes such as gastroscopes, laparoscopes and arthroscopes.

The present method overcomes the drawbacks of prior methods known in the art. The antifogging composition is biocompatible and biodegradable.

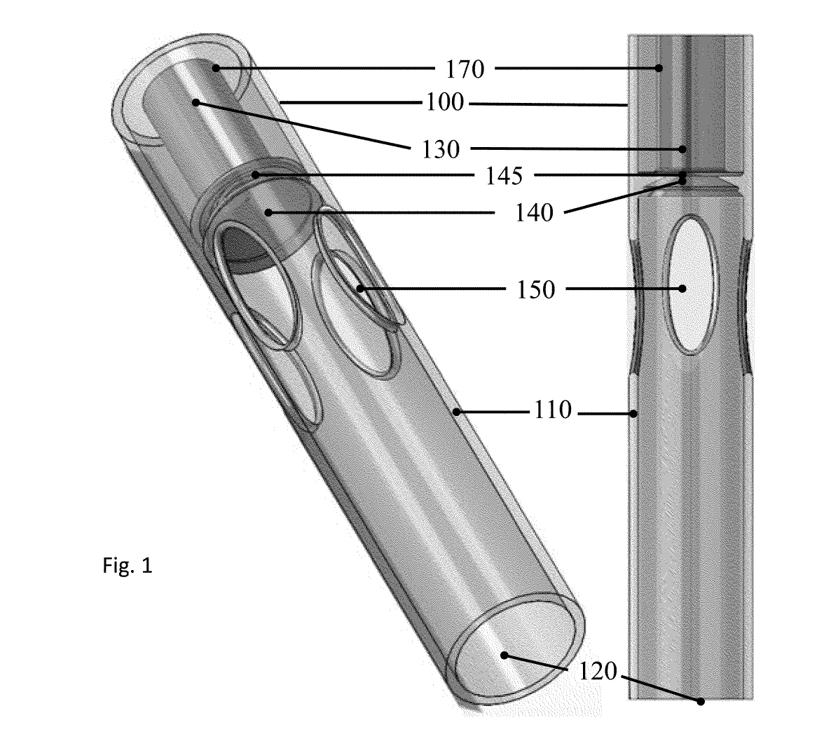

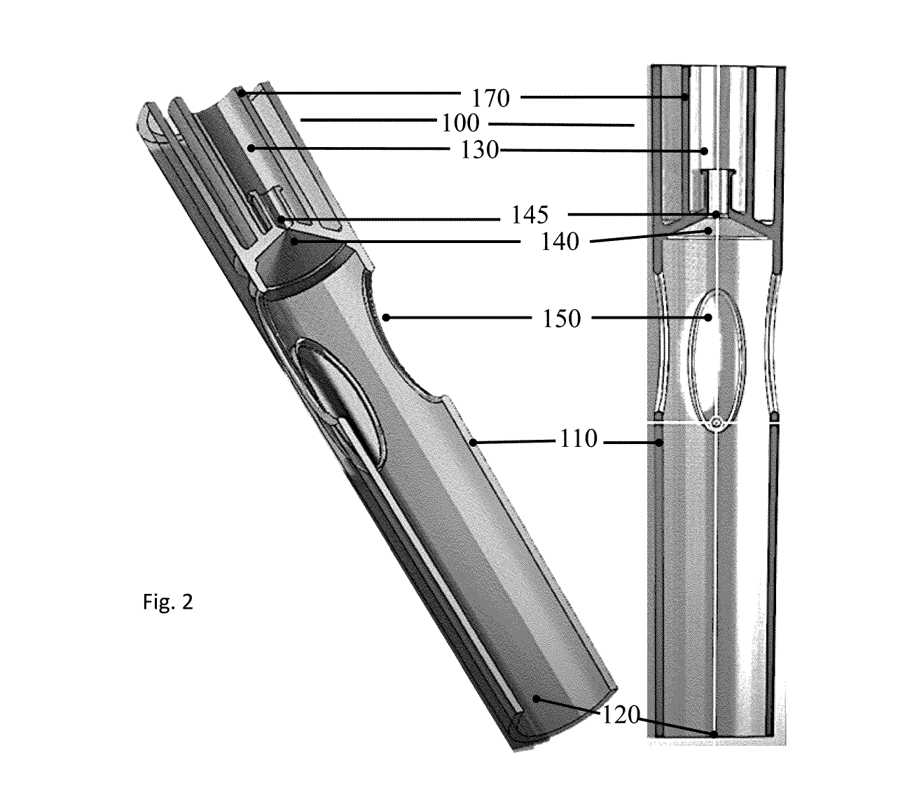

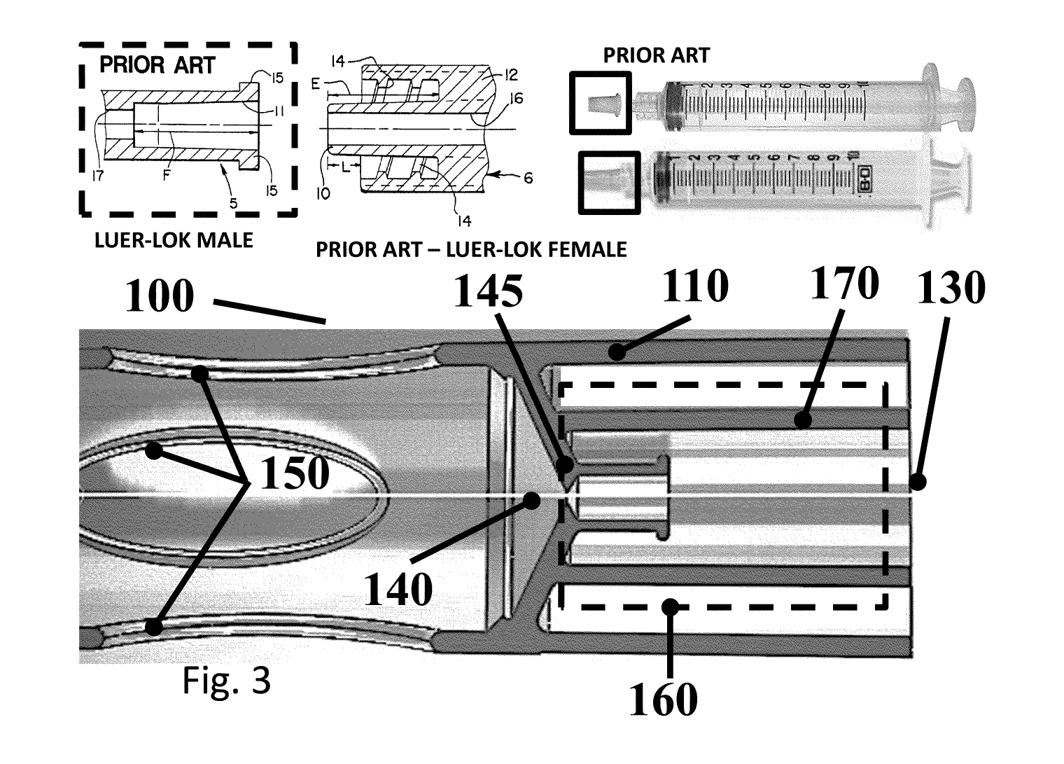

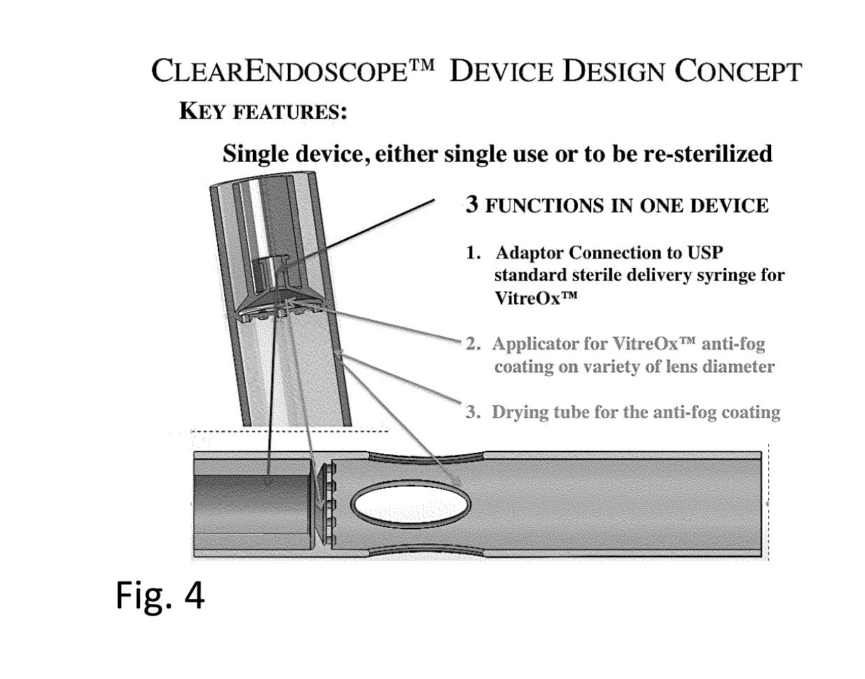

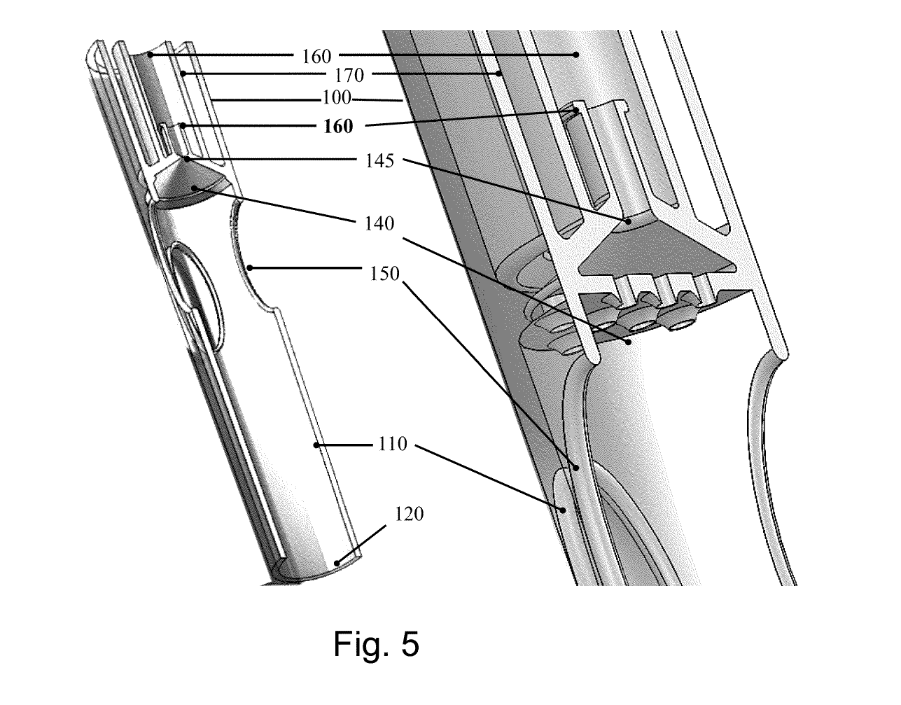

FIG. 1 and FIG. 2 depicts an applying device 100 that is useful for delivering an antifogging composition (AFC) to a lens such as an endoscope lens. In the embodiment shown in FIG. 1 and FIG. 2, applying device 100 has a cylindrical wall 110, although those of ordinary skill in the art will recognize that the outer shape of applying device 100 can function with a variety of outer shapes. Applying device 100 has an open end 120 that receives the distal end of a medical device that will receive an AFC. One function of open end 120 is to mechanically stabilize the endoscope. Applying device 100 also has an AFC end 130, which is used for supplying an AFC to applying device 100. The diameter of applying device 100 ranges from 1-21 mm—1, 1.2, 1.9, 2, 2.7, 3, 4.5, 5, 6, 7, 8, 9, 10, 11, 12, 21, or 23 mm.

Open end 120 and AFC end 130 meet at transition 145. The distance between transition 145 and the end of open end 120 is 120-300 mm or 150-300 mm. The distance between transition 145 and the end of AFC end 130 is 20-70 or 30-70 mm.

AFC end 130 is configured to receive AFC and transfer it to a conical dipping cup 140. In other embodiments, dipping cup 140 can have a shape other than conical without affecting the dipping cup's function.

Applying device 100 as shown in FIG. 1 and FIG. 2 also has a drying window 150. These openings allow air flow to promote drying of the AFC.

In various embodiments, applying device 100 comprises a material that can be any one or any combination of Pellethanes, PEBAs, Pebaxes, fluoropolymers, polytetrafluoroethylenes, polyesters, silicones, polyethylenes, polypropylenes, nylons, polyolefins, polyimides, polycarbonates, PVCs, polystyrenes, thermoplastic elastomers, thermoplastic materials, curable elastomer materials, fluorine-containing thermoplastic materials, fluorine-containing elastomers, ethylene-vinyl acetate copolymers, polyamides, polyethylene terephthalates (PET), polybutylene terephthalates (PBT), co(ethylene-tetrafluoroethylene), and polyurethanes. Applying device 100 can comprise any polymer as considered acceptable by those of ordinary skill in the art.

### AFC Composition I

For purposes of this document, AFC includes a composition comprising a mixture of (a) a solvated viscoelastic polymeric gel, comprising a viscoelastic polymer having a molecular weight of between about 20,000 Da and about 4,000,000 Da; and (b) purified water; wherein the volume ratio of (a) to (b) is between about 1:1 and about 1:5 and the composition has a conductivity of less than about 250 μS/m. In some embodiments, the ratio of (a) to (b) is between about 1:2 and about 1:3. In some embodiments, the purified water has resistivity of about of between, about 60 kΩ-cm to about 17.9 MΩ-cm; more specifically the purified water preferably has resistivity of about 2 MΩ-cm. The composition of the present invention may comprise between 0.0003 wt % and 10 wt % of the viscoelastic polymer.

For some embodiments of the composition, the solvated viscoelastic polymeric gel comprises a viscoelastic polymer having a molecular weight of between about 20,000 Da and about 500,000 Da or between about 20,000 Da and about 200,000 Da. For some aspects, solvated viscoelastic polymeric gel comprises a viscoelastic polymer that is at least 60% fully hydrated. In some aspects, the viscosity of the solvated viscoelastic polymeric gel is about 500 cP to about 5,000 cP, or more specifically about 1,000 cP to about 4,000 cP.

In some aspects of the composition, the solvated viscoelastic polymeric gel may be homogenous. The solvated viscoelastic polymeric gel may comprise cellulose ester or a cellulose ether. The cellulose ester is any one or any combination of cellulose acetate, cellulose triacetate, cellulose butyrate, cellulose propionate, cellulose phthalate, cellulose nitrate, cellulose sulfate, cellulose phosphate, cellulose acetate propionate, cellulose acetate butyrate, cellulose acetate phthalate, and cellulose nitrate acetate. And the cellulose ether is any one or any combination methyl cellulose, ethyl cellulose, ethyl methyl cellulose, benzyl cellulose, hydroxyethyl cellulose, hydroxypropyl cellulose (HPC), hydroxyethyl methyl cellulose, hydroxypropyl methyl cellulose (HPMC), ethyl hydroxyethyl cellulose, and carboxymethyl cellulose (CMC). The solvated viscoelastic polymeric gel may also comprise a basic cellulose monomer with the chemical formula C₃₂H₆₀O₁ and a molecular weight of 748.8 grams/mole in the stoichiometry C₆H₇O₂(OH)ₓ(OCH₃)_{y}(OC₃H₇)_{z}, wherein x+y+z=3. In other embodiments, the solvated viscoelastic polymeric gel comprises glycosaminoglycan. Glycosaminoglycan is selected from the group consisting of hyaluronan, heparan sulfate, heparin, keratan sulfate, dermatan sulfate, and chondroitin sulfate.

### AFC Composition II

For purposes of this document, AFC include another class of compositions. These compositions are based in part on AFC Composition I material, but with added metallic particles.

Adding metallic particles helps create more resilient, more adherent, and more compliant coatings while retaining the coatings' optical clarity and anti-fog properties. In some embodiments, metallic particles include metal nanoparticles that help increase coating stability and integrity. Metallic particles enhance coating sterility because the particles have their own antimicrobial characteristics.

In these or other embodiments, the metal particles include submicron metal or metal oxides particles. In some embodiments, the nanoparticles are completely embedded or incorporated into the film. After these particles are incorporated into the application fluid and then the dry coating, there are not any free nanoparticles. For some embodiments depositing coatings containing metallic particles, sizes below 200 nm support optical clarity. In some embodiments, useful metallic particles lie within a 1-3 nm size distribution.

Coatings for use with this applying device described in this document can use a concentration of 250-500 ppm, 1-10 ppm, or 1-5 ppm of metallic particles. The coatings use very pure deionized water with 0.5-2 MΩ-cm resistivity for preparation and dilution. Using this water purity provides total dissolved solids (TDS) below 1 ppm.

This purity level helps maintain the activity and size of the metallic particles.

Some coatings use Zn, Ag, or a particle containing both or oxides of Zn, Ag, or a particle containing both where a full range useful compositions include particles with Zn:Ag in a 1:0 to 0:1 ratio.

Selection of the metal for the coating can tune absorptions of the coatings, which are typically between 2-4%.

Some coating formulations use any one or any combination of Ag, Zn, or Sn particles or oxides. Since these material all absorb UV, varying the concentration of these materials tailors or controls UV absorption. Controlling pH is a way of controlling the concentration.

In addition to Ag, Zn, or Sn embedded nanoparticles can comprise other metals and metal oxides.

Non-toxic metals and metals compatible with human tissues or needed in trace amounts for human health can be used to improve coating safety, to avoid allergic reactions (if coatings contact skin, organs, or tissue—especially eyes) and to increase environmental sustainability.

Zn and Ag are environmentally benign.

Other metals and metal oxides particles can also be used in various combinations, such as binary, ternary, quaternary, compositions etc. as needed, as available, or as suitable to tailor UV absorption or pH. In some embodiments, suitable compositions include Group 1 elements; Lithium (Li), Sodium (Na), Potassium (K) are examples of Group 1 elements. In these or other embodiments, suitable compositions include Group 2 elements; Magnesium (Mg), Calcium (Ca) are examples of Group 2 elements. In these or other embodiments, suitable compositions include transition metals; Titanium (Ti), Chromium (Cr), Nickel (Ni), Palladium (Pd), Platinum (Pt), Gold (Au) are examples of transition metals. In these or other embodiments, suitable compositions include Group 13 elements; Aluminum (Al) is an example of a Group 13 element.

They can be used for application on instrumentation dials and domes.

### Physics of Condensation—How Fogging Occurs and its Effects on Optics

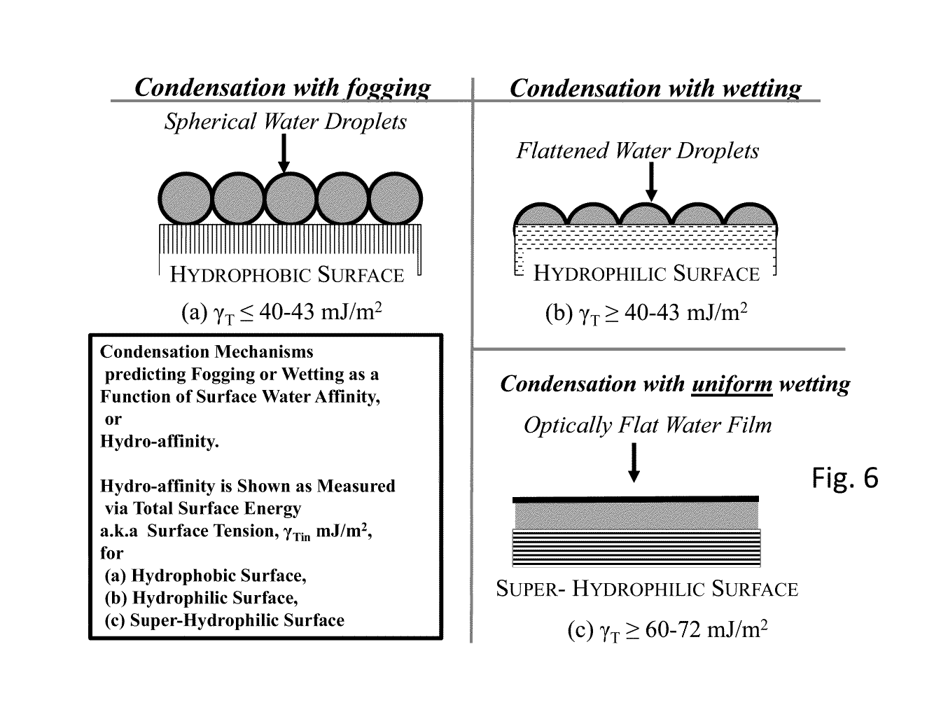

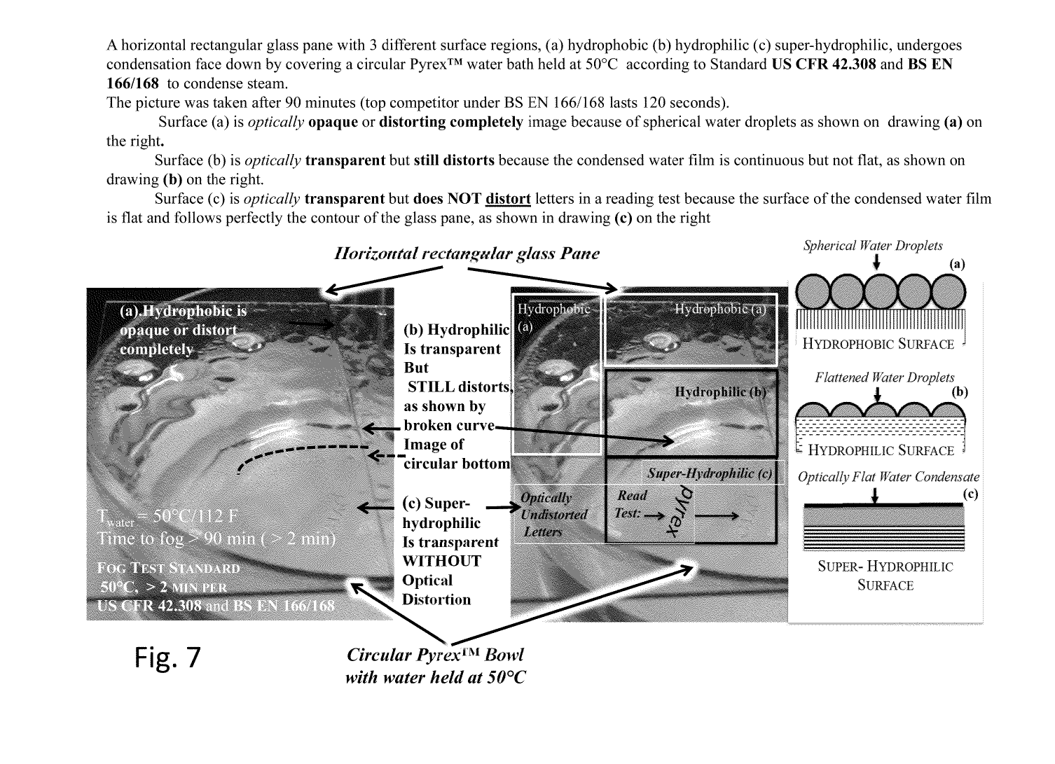

As shown in FIG. 6 in a schematic, and in FIG. 7 with the corresponding measurement and data, when water condenses on a surface, three different events can happen: (a) condensation with fogging (FIG. 6(a) and FIG. 7(a)), that renders the surface opaque or cloudy, and does not allow image transmission; (b) condensation with wetting (FIG. 6(b) and FIG. 7(b)) which renders the surface transparent by allowing light to be transmitted, but still distorts images transmitted, and (c) condensation with uniform wetting (FIG. 6(c) and FIG. 7(c)) that renders the surface both transparent to light and undistorted images to be transmitted. The latter image in FIG. 7(c) shows the testing for distortion by comparing transmitted images of letters through the surface and comparing to the image. Condensation with uniform wetting eliminates distortion from transmitted images and letters to less than 1 or 2%.

Fogging is typical of hydrophobic (water-fearing) surfaces having a low affinity for water. These surfaces are also characterized as having “low surface energy”, which means that they have a low energy of interaction with any matter interacting with the surface that can now be measured by methods developed, improved and now deployable as a metrology for anti-fog technology characterization, specifically Three Liquid Contact Angle Analysis (3LCAA). [Ross Bennett-Kennett, Senior Thesis, Arizona State University (2013); Role of Surface Energy, Hydroaffinity, and Topography in Nanobonding of Si(100) with Silica Polymorphs Using a Cristobalite Precursor Phase: A Quantitative Analysis and Atomistic Model, Ross Bennett-Kennett; •Samuel James Farmer; •Shawn Whaley; •Ashlee Murphy; •Brance Hudzietz; •Matthew T. Bade; •Nicole Herbots, American Association for the Advancement of Science 2012 Annual Meeting; February 2012; Measuring Surface Energy and Reactivity of SiO2 Using the Van Oss Theory and Three Liquid Contact Angle Analysis, Ashley A Mascareno; Alex L Brimhall; Ender W. Davis; •Matthew T. Bade; •Nithin Kannan; •Abijith Krishnan; •Nicole Herbots; •Clarizza F. Watson, Bulletin of the American Physical Society (APS), Annual Meeting of the APS Four Corners Section, Tempe, Ariz., Volume: Volume 60, number 11 (2015); IBMM of OH adsorbates and interphases on Si-based materials, N. Herbots; •Qian Xing; •M. Hart; •J. D. Bradley; •D. A. Sell; •R. J. Culbertson; •Barry J. Wilkens, Nuclear Instruments and Methods in Physics Research Section B Beam Interactions with Materials and Atoms February 2012; 272:330-333.]

The range of values measured for hydrophobic surface energies is typically about 20 mJ/m² to below 40-45 mJ/m². As a reference, the surface energy of pure water is 72 mJ/m².

Low affinity to water—or low surface energy of interaction—leads to more spherical droplets because water molecules have interact more with each other than with the surface molecules.

The formation of spherical droplets trapping air between each other as they grow and impinge on each other leads to a high number of small air-water interfaces, which have high curvature. This results in many different angles of refractions, so that light transmission and image transmission are scattered by the droplets. The surface appears opaque or cloudy—not transparent.

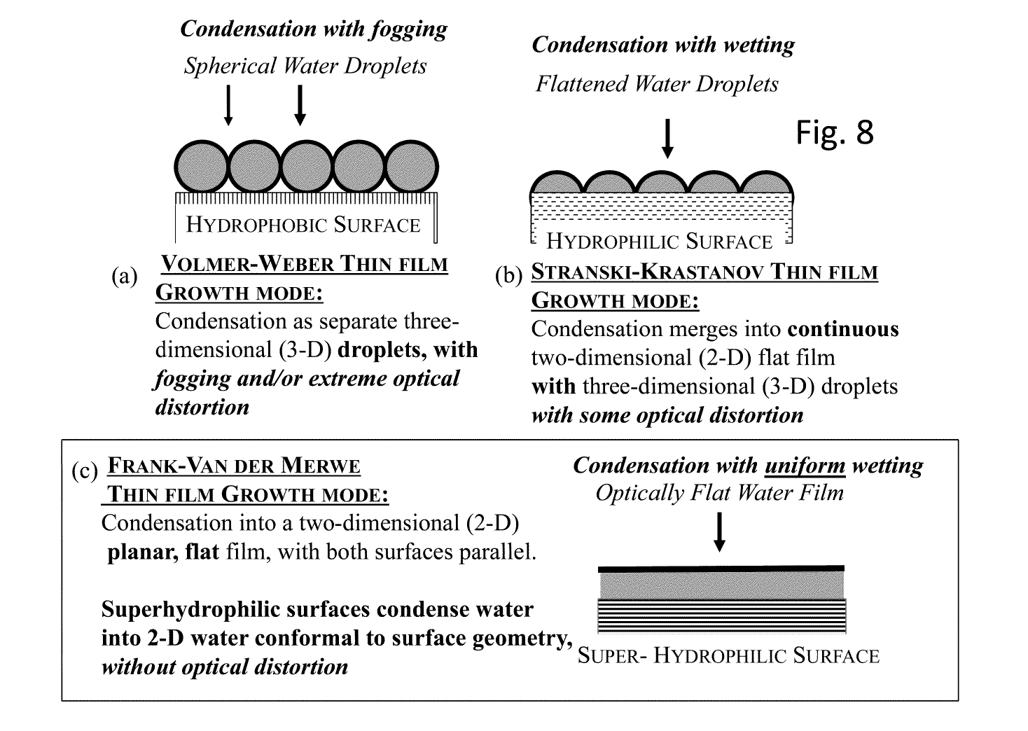

FIG. 6(a) and FIG. 8(a) show condensation with fogging, when condensing water forms highly curved droplets on the surface that is hydrophobic. When these coalesce, they lead to an uneven distribution of droplets, which may impinge on each other but still retain their individual interfaces, with a highly curved geometry instead of flattening droplets.

Such a surface, as clearly seen in Figure X2(a) is not transparent. This lack of transparency is called fogging because images cannot be transmitted through the condensed droplets.

Light rays cannot transmit an image via a parallel bundle through three-dimensional (3D) droplets but are instead scattered in numerous directions. The surface appears opaque with a white, milky appearance because when white light hits the high curvature of the small water droplets with ambient air, all the light rays refract at the air-water interface at different lengths depending on their wavelength (or color). This effect leads to a whitish appearance, from all the different colors scattering in all directions and thus overlapping in the whole spectrum, leading to a whitish surface without discernable image

Even when exposure to condensation is prolonged and droplets ripen into larger droplets, they maintain their high curvature, and act as an array lenses which all distort individually the image, and for practical purpose, such surfaces still do not qualify as transparent, as seen in FIG. 7(a) when even lines and edges under the hydrophobic glass planes do not retain any of their linear or circular shape.

But condensation with wetting is typical of hydrophilic (water-loving) surfaces. Their high affinity for water leads to much flatter droplets than hydrophobic ones. As depicted in FIG. 6(b) and shown in FIG. 7(b) in the matching box marked “hydrophilic (b)”, individual droplets cannot be distinguished not optically separated.

The degree of affinity of these surfaces with water, hydro-affinity, is again measured by how spherical or flat a droplet is on such a surface by 3LCAA. The value of surface energy is higher for hydrophilic surfaces than hydrophobic surfaces. Hydrophilic properties flatten water droplets into a uniform, film wetting the surface. This leads to a clearer, more transparent surface than a hydrophobic surface undergoing condensation with fogging. Light refraction, scattering, and image distortion decreases, as seen on FIG. 6(b) and FIG. 6(c), and FIG. 7(b) and FIG. 7(c). However, to eliminate any visible optical distortion, the “lensing” effect due to the possible remaining curvature of the water surface still distorts images, and just like the separate droplets has to be completely eliminated: the droplets have to be absolutely flat from the start.

To eliminate image distortion and maximize light and thus image transmission, the interface between air and water has to be “geometrically planar” or “flat” when wetting occurs during condensation. This ensures that all light rays and image are transmitted parallel to each other and eliminate the multiple angle of refraction and scattering caused by curvature, reducing to one single angle. This is called condensation with uniform wetting as shown in FIG. 6(c) and FIG. 7(c).

The present invention produces super-hydrophilic surfaces shown in FIG. 7(c) and FIG. 8(c) where the initial water droplets are formed below the optical detection limit and do not produce detectable refraction or scattering effect, but coalesce without optical incubation time in flat water films or sheets with a planar air-water interface where light is at least 96-98% transmitted and optical distortion is below 1-2%.

This means there is no visible transient fogging effect, until the film coalesce. The surface remains continuously transparent in the range of wavelengths or visible light used for images observation, without a transient period when the film form. This is accomplished by flattening initial droplets formation conformally to the surface in flat sheets whose size does not affect wavelengths or visible light used for images observation.

For example by keeping the individual droplets small and flat, at the nanoscale, as the first molecular layer of water on the surface is formed, this initial water layer is at first discontinuous when there is not enough water molecules yet on the surface to form a complete molecular layer. The key point is that unlike non-super hydrophilic surfaces, the water molecules will not draw together into droplets, but remain in flat sheets. This is what separates super-hydrophilic surfaces from hydrophilic surfaces, where the droplets from a continuous film but still maintain a surface topography that main be not entirely planar and hydrophobic surfaces where the droplets still maintain their distinct spherical boundaries and acts as refracting lenses.

In other words, on super-hydrophilic surfaces, initial condensation gathers in flat water patches whose height is at most a few molecular layers in thickness <1 nm, <20 nm, <200 nm for example depending on the formulation and application of the anti-fog coatings. These dimensions are too low to create scattering at wavelengths near and within the optical range 350-700 nm, and beyond, which creates transparency.

In summary, the difference in condensing water films growth and surface topography for three types of surfaces (a) hydrophobic, (b) hydrophilic, and (c) super-hydrophilic surfaces matches the three classical thin film growth modes:

(1) the three-dimensional thin film growth mode as the Volmer-Weber thin film growth mode, as shown in FIG. 8(a),
(2) the mixture of two-dimensional continuous thin films with three-dimensional features, known as the Stranski-Krastanov thin film growth mode,
(3) the two-dimensional thin film growth mode as the Volmer-Weber thin film growth mode, as shown in FIG. 8(a), FIG. 8(b), FIG. 8(c). These three growth modes correspond optically to fogged surfaces.

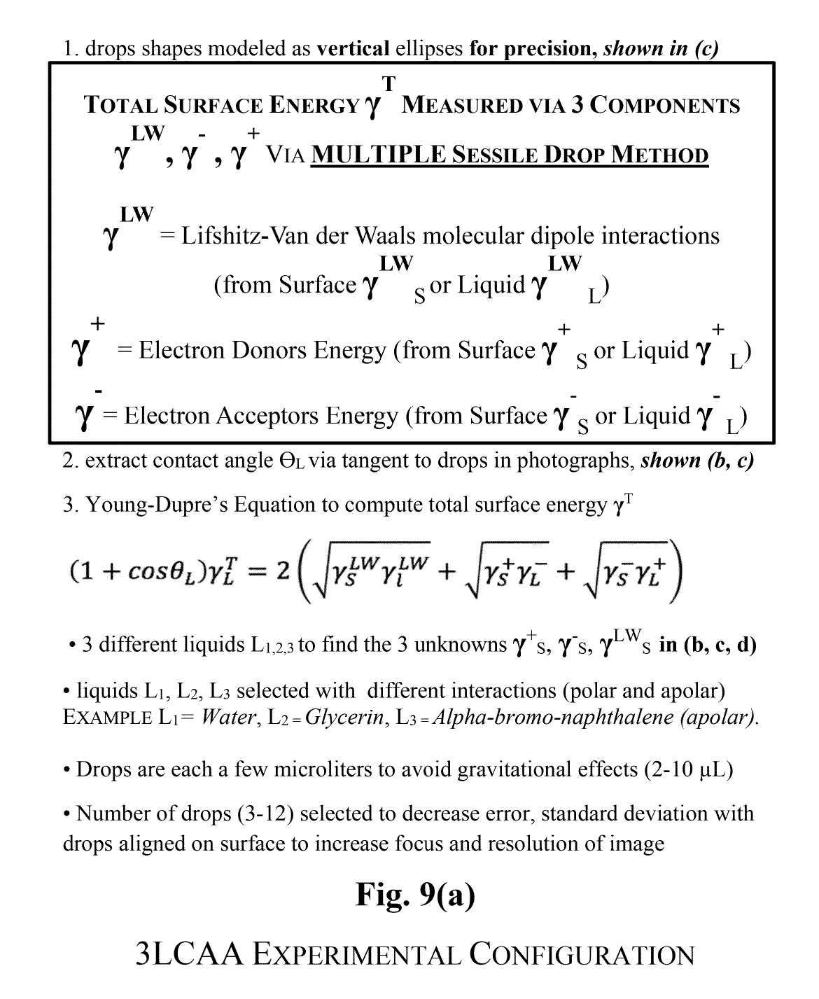

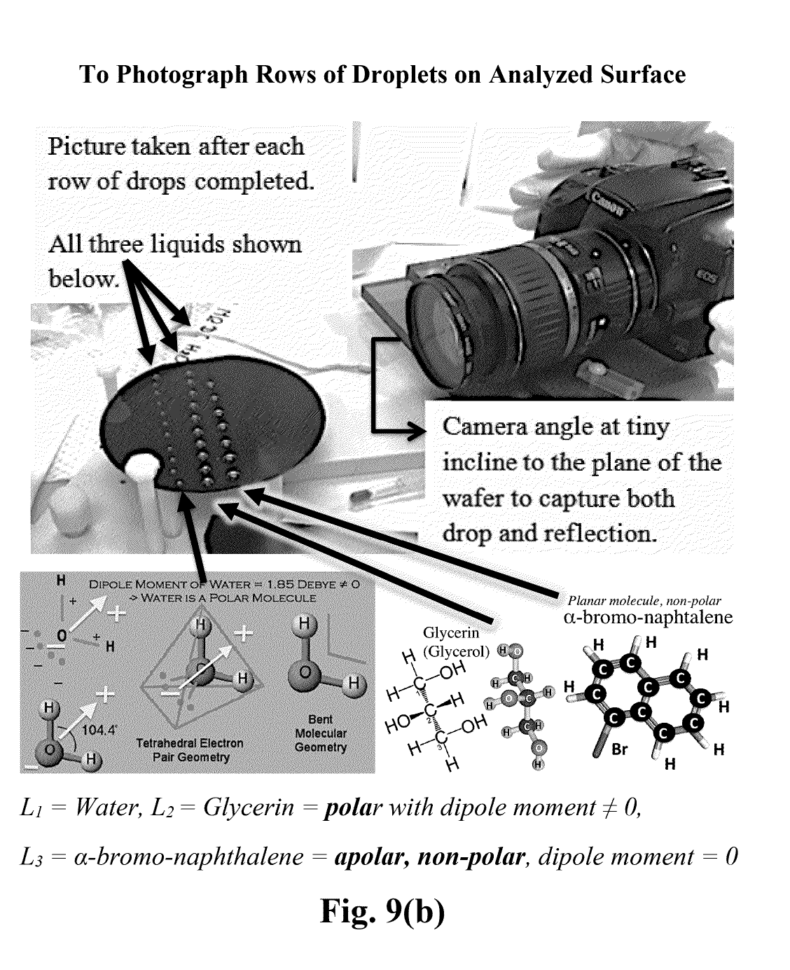

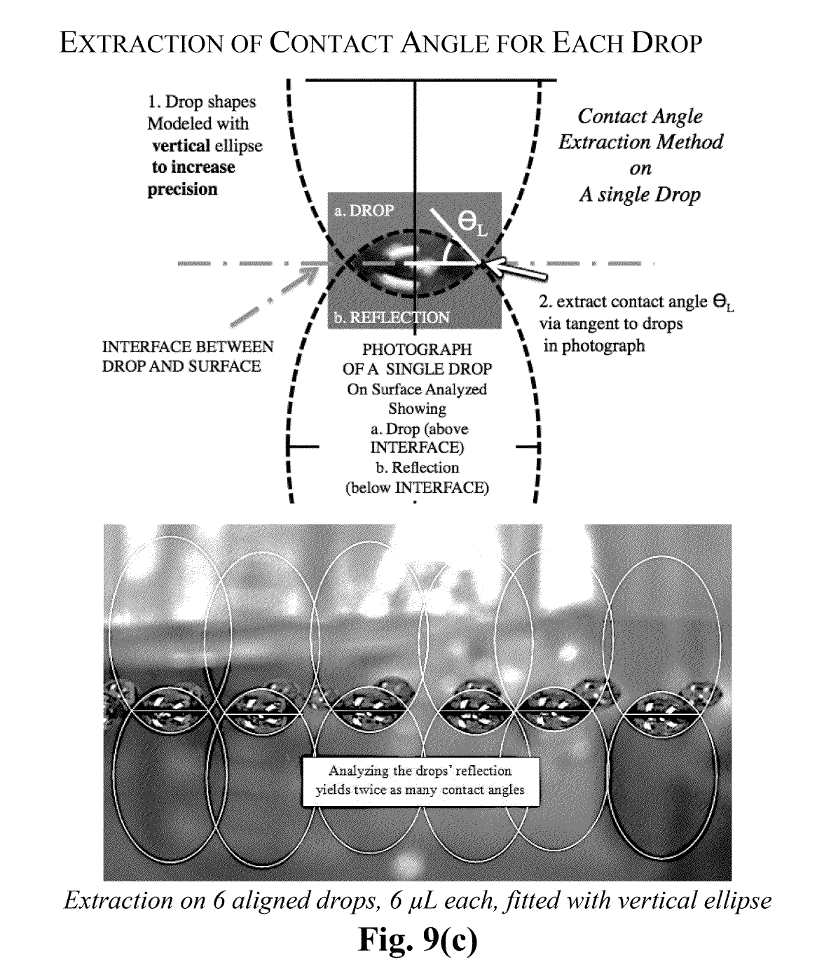

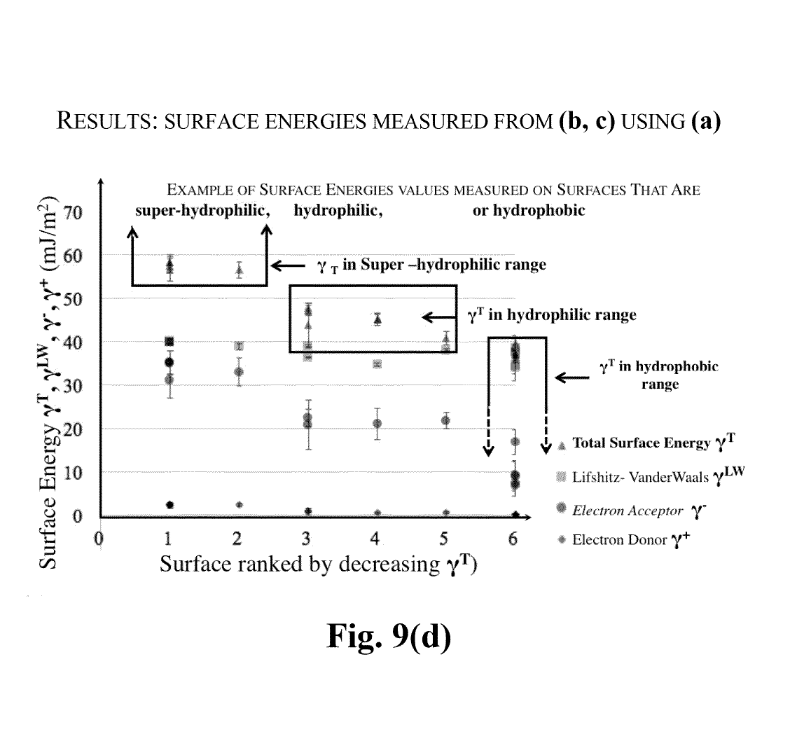

Surface energy is a measurement of interactions between the surface and any substance above it. (See FIGS. 9(a), (b), (c), and (d)).

(a) Principles on ow surface energy is measured
(b) Experimental Set-up showing how surface energy is measured
(c) Elliptical fits for complete set of measurements
(d) Resulting surface energy measurements for different surfaces

Interactions vary with surface atomic species and geometry—essentially, what atoms are on the surface, and how they are organized interactions depends on whether atomics species and defects are electron acceptors or donors—denoted their contributions to surface energy gamma plus and gamma minus. an electron donor donates an electron, while an electron acceptor, like a positive ion, is ready to accept an electron. these can be situated inside or outside the tested surface. this discussion defines a species as an electron acceptors or donor from the point of view of being outside the silicon surface. a third contribution to surface energy is due to interactions between molecular dipoles on the surface with outside molecules. in this document they are modeled as Lifshitz-Van der Waals interactions, and their contributions to surface energy are denoted gamma lw. Water molecules happen to be very strong electrical dipoles—H2O has an end that is primarily positive, where the Hydrogen atoms are, and an end that is primarily negative, where the oxygen atom is. The negative end of one H2O molecule attracts the positive end of another H2O, and so we get anti-parallel alignment between the two. this can occur throughout an entire drop of water. Molecular interactions of this type between a silicon wafer and other molecules of substance outside the surface contribute to the total surface energy. Typically, surface energy is measured through a wetting process. The surface is wetted and the way the molecules in the liquid interacts with the surface illustrates something about the surface energy. Three different liquids are used, 2 polar—water and glycerin, and one non-polar—alpha-bromo-naphthalene. Each is a well characterized liquid that behaves with the surface differently. Smooth, ordered surfaces are required. Also, the surfaces require a controlled chemical and hydro-affinity—the surfaces will bond with water molecules. Surface energy measurements are important for making a super-hydrophilic coating with a flat, conformal surface geometry that does not produce optical image distortion. Total surface energy is a measurement of how strong interactions will be.

In other words, for electron exchange to occur, the system needs two surfaces that both can only accept electrons or two that can only donate.

One has to be more likely to donate electrons and one has to be more likely to accept electrons.

This has application in medical device implants—particularly those in wet saline environments, like the permanent glucose sensor for diabetics. It can reduce scarring or scar tissue formation because the super-hydrophilic properties enables the surface to wet easily and assimilate with tissue and organs instead being an irritant. in the super-hydrophilic coating, by creating a simple continuous water film adhering to the implant creates a stable barrier between the implants materials and the tissues, organs and bodily fluids. This water barrier is completely compatible with most tissues.

### Application of Hydrophilic Coating on Medical Implants

Medical implants are a foreign object in the human body, and can lead to increase of scar tissue, infection, and rejection. This is especially evident with implants with metal surfaces, even though materials for implants are ideally biocompatible, corrosion resistant, and inert. Unfortunately, some medical implants become a necessity in the lives of many patients. The initial stages of implant integration into the body involve the adsorption of blood and bodily fluids (composed mostly of water) on the implant surface. A hydrophilic surface can improve the assimilation of the implant into the human body, by increasing the wettability of the implant surface.

Some embodiments do not heat the lens to coat the lens and some embodiments do not need removal of water that may build up on a lens.

### EXAMPLE

The objective of the study is to determine the effectiveness of the VitreOx™ anti-fog coating in a simulated closed-body-cavity surgery procedure. This test lasted 30 minutes.

### Materials

VitreOx™ anti-fog fluid
Stainless steel wide-mouth vessel, with an orifice located on the bottom's center
2 Mega Ohm deionized water
Borosilicate glass basin (to heat water)
Temperature-controlled hot plate
Digital thermometer
Timer
Large printed letters (as an object to focus on during the test)
Clarus 10000 endoscope
Alcohol
Lint-free optical wipes

### Procedures

Clean the scope lens with alcohol and optical wipe. Rinse with 2 Mega Ohm deionized water, and dry with clean optical wipe.

Familiarize the user with the Clarus 10000 scope, i.e. adjusting the focus and lighting.

Use the temperature controlled hot plate, heat the 2 Mega Ohm deionized water in the borosilicate glass basin. Set the temperature to 36.6° Celsius (98° Fahrenheit).

Arrange the large printed letters, or object at the mouth of the stainless steel vessel.

Place the stainless vessel (orifice facing up), on top of the borosilicate glass basin.

Place the Clarus 10000 scope (without VitreOx™) into the orifice of the stainless steel vessel. Begin timer, and observe time when fogging began.

Once the scope fogs, remove the scope from the stainless steel. Rinse the lens with 2 Mega Ohm deionized water, and wipe dry with optical wipe.

Apply a few drop of VitreOx™, with dropper on the lens of the scope, and allow VitreOx™ to dry.

Once the VitreOx™ is dried on the lens, insert the scope into the orifice of the stainless steel vessel. Begin time, and observe time if fogging begins.

### Observations

The scope lens that was not treated with VitreOx™ fogged almost immediately upon placing the scope into the stainless steel vessel, and exposing it to the body-temperature.

The scope lens that was not treated with VitreOx™ was tested several times to ensure that lens were indeed fogging, as opposed to defects, etc., of the scope.

The treated scope did not fog, and was focused on the card with the SiO2 Nanotech logo. The letters remained legible over the course of the test (30 minutes).

At 12 minutes, the letters appear to become “crisper” over time, especially at the edge of the lens.

### Results

VitreOx™ anti-fog coating demonstrated effectiveness during the 30-minute, simulated procedure. It remained fog-free for the entire duration of the test and did not require reapplying AFC. Furthermore, it seemed that it improved the lens, as objects became even clearer or crisper over time.

### EXAMPLE II

### Objectives

The two main objectives of the experiment: 1) To demonstrate that VitreOx™ prevents the lenses of medical scopes from fogging without reapplication, while being are used for closed body surgeries and procedures; and 2) To demonstrate safety and the benign properties of the VitreOx™, by demonstrating the animals that are being studied will not suffer adverse effects from the use of the medical device VitreOx™.

### Overview

A control, a Karl Storz scope without any anti-fog treatment, will be used to prove the phenomenon of fogging due to condensation on medical scopes. Then, the control will be compared with the 2 anti-fogging products: Covidien Clearify (formerly New Wave D.E.L.P.), and VitreOx™. By comparing the anti-fogging effect of VitreOx™ with these product, the test results would demonstrate VitreOx™ effectiveness as an anti-fog coating for medical scopes.

### Pass/Fail Criteria

The pass/fail criteria of the effectiveness test is can the VitreOx™-treated scope resist fogging for the entire 90 minute duration of the gastrointestinal exploratory procedure of pig A2. In addition, A2 will be observed for 10 additional days after the procedure to ensure it did not suffer any complications as a result of the procedure. The conclusion of the 90 minute gastrointestinal procedure, and the 10-day period of observation will be the endpoint of the in vivo study.

### Materials

VitreOx™ with dropper applicator
Covidien's Clearify Visualization System®
Two identical autoclaveble 4 mm scope (control group+experimental group) for each experiment. In this case, they are identical, with the exception that one is 45 degrees, and one is straight.
Control—verify both (untreated) scopes initially fog
Exploratory—side-by-side of VitreOx™ and Clearify
Monitor+video recorder
Trocar (port to avoid contact between the scope's lens and the pig's body fluids and tissues)
(2) Pigs (Yucatan)—same age, sex, size, and blood type/group (if possible) bought from a licensed swine research company
Clean surface/table
Anesthesia (it needs to last for a minimum of 90 minutes)
Scalpel
Stitching material
Timer

In order to conduct the experiment, 2 Yucatan™ pigs of the same age, sex, size and blood group/type were used. In terms of the medical scope, the experimenters used 2 identical autoclavable 4 mm scopes from Karl Storz® for each experiment. One 4 mm scope was treated with VitreOx™ and the other was treated with Clearify®. A trocar was used as a port to avoid contact between the scope's lens and the pig's body fluids and tissues. Finally, the whole experiment was recorded using a monitor and video recorder for the purposes of documentation.

### Procedures

### Overview

First, the animal was submitted to a gas anesthesia, after which the gastrointestinal area of the animal, where the scope was supposed to be inserted, was prepared to avoid any contamination. This was done by using a trocar/port of entry for the scope, and using CO2 to inflate the body cavity of the pig, in order to simulate surgeries performed on human subjects. After that, two scopes were prepared: on the first one, 1-2 drops of VitreOX™ were applied and it was left to dry for approximately 5-10 minutes in room temperature. The second scope was warmed and the Clearify® solution was applied. Both the VitreOx™- and the Clearify®-treated scopes were placed inside each pig's body, respectively, and were left there for 90 minutes. For the control procedure, a clean and untreated scope was placed inside a pig's body and left for the same duration of 90 minutes to confirm that condensation does indeed cause the scope to fog.

### Detailed Procedures

### Control

After submitting the animal to a gas anesthesia, the gastrointestinal area is cleaned with iodine, in order to avoid contamination, especially on the scope's lens.

CO₂ is used to inflate the body cavity of the pig, to simulate closed body cavity surgeries performed on human subjects.

A scope without any treatment of anti-fog, was inserted into the pig A1 to demonstrate that the scope has the issue of fogging due to condensation.

After the control procedure was completed, the scopes were sterilized/cleaned according to the manufacturer's cleaning standard (isopropyl alcohol 100% impregnated cloth to clean the outer surfaces of the endoscope, and isopropyl alcohol 100% impregnated cotton swabs to clean the optical surfaces) to prepare it for treatment.

### Exploratory 1—Pig A1

Since there was a limitation with the video monitor (1 instead of 2), the exploratory procedures had to be conducted in succession, instead of in parallel, or side-by-side.

After submitting the animal to a gas anesthesia, the gastrointestinal area was cleaned with iodine, in order to avoid contamination, especially on the scope's lens. After that, the animal's body cavity was opened using a scalpel to make a small incision to fit the trocar and the size of the scope's caliber 4 mm.

CO₂ was used to inflate the body cavity of the pig (A1), to simulate closed body cavity surgeries performed on human subjects.

The 4 mm scope was treated with the Covidien Clearify System, by inserting the scope into the scope warmer with the surfactant.

The scope was then placed inside the pig (A1) through the trocar for 90 minutes, and the scope was monitored for fogging.

### Exploratory 2—Pig A2

A1 was placed in a recovery room, and pig (A2) was submitted under anesthesia. This was to ensure that A1 does not suffer any adverse effects of being under anesthesia for a long duration.

CO₂ was used to inflate the body cavity of the pig, to simulate closed body cavity surgeries performed on human subjects.

The 4 mm scope was treated with VitreOx™, by inserting the scope into the scope warmer with the surfactant.

The scope was then placed inside the pig (A2) through the trocar for 90 minutes, and the scope was monitored for fogging.

### Notable Surgical Environment Conditions

Surgical Room Temperature:

Between 68° F. and 73° F. (20° C. to 23° C.). “The recommended temperature range in an operating room is between 68° F. and 73° F. (20° C. to 23° C.). Collaborate with infection prevention, and facility engineers when determining temperature ranges. Each facility should determine acceptable ranges for temperature in accordance with regulatory and accrediting agencies. The temperature should be monitored and recorded daily using a log or electronic documentation of the heating, ventilation, and air conditioning (HVAC) system”

Body Temperature Fluctuations:

“The body temperature increase under stress. When doctors operate—especially in high-pressure situations—they tend to get warm and start to sweat. Operating rooms are kept colder than normal so the surgeons and nurses feel comfortable. It's important that the patient's body temperature doesn't drop too much. If they get too cold, their blood won't clot properly, and they actually may be at a higher risk of infection. Often, once the medical staff gets to the operating room, they'll cover the patient with a heated blanket or give them a heating pad.

Other Factors in Temperature:

The temperature range of blanket or linen warming cabinets should not exceed 130° F. (54.4° C.) “Surgeons also have preferences when it comes to temperature conditions. Reasons for these preferences range from personal comfort while dressed in heavy surgery clothing to the perception of superior procedure success rates. Often, the result is that the surgeon expects a lower room temperature than that stated in guidelines.

Surgical Room Humidity:

“The recommended humidity range in an operating room is 20% to 60% based upon addendum d to ANSI/ASHRAE/ASHE Standard 170-2008. Each facility should determine acceptable ranges for humidity in accordance with regulatory and accrediting agencies and local regulations. The center for Medicaid and Medicare systems has modified their requirements to allow for the 20% lower limit. Temperature and humidity should be monitored and recorded daily using a log or electronic documentation of the heating, ventilation, and air conditioning (HVAC) system.

Karl Storz® Scopes:

The composition of the lens is proprietary. “Manual cleaning: Endoscopes are easy to care for and do not require preventive maintenance. However, it is important to clean the product immediately after use. This is an easy way to prevent the deterioration of functionality and hence image quality. We recommend using a soft, Isopropyl alcohol (100%)-impregnated cloth to clean the outer surfaces of the endoscope. For the cleaning of the optical surfaces (objective lens, eyepiece, and light guide connector), we recommend using Isopropyl alcohol (100%)-impregnated cotton swabs.

Using CO₂ to Fill the Body Cavity:

This elevates the abdominal wall above the internal organs to create a working and viewing space. CO₂ is used because it is common to the human body and can be absorbed by tissue and removed by the respiratory system. CO₂ is also non-flammable, which is important because electrosurgical devices are commonly used in laparoscopic procedures.

### Observations

The main question that needed to be answered by the experiment was whether VitreOx™ kept the scope's lens fog-free for the entire 90-minute duration, and if not, how long did it last until it required reapplication.

Therefore, the endpoint of the study was the scope being kept in the cavity for 90 minutes. The parameter under study in the experiment was the amount of fogging of the respective scopes.

The pass/fail criteria of the experiment was whether VitreOx™ would be able to prevent fogging of the scope for a longer time as compared to both Covidien Clearify®-treated scope, as well as the control (untreated) scope.

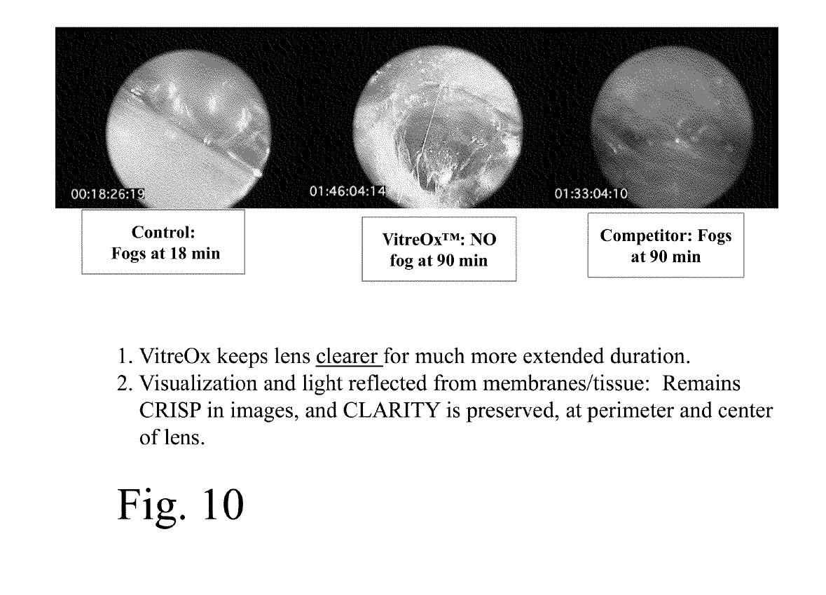

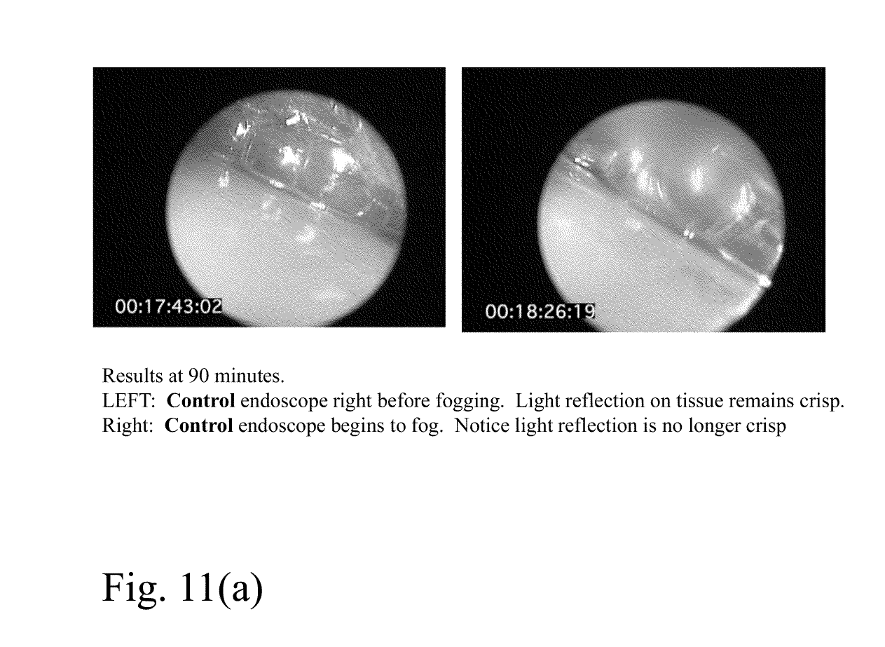

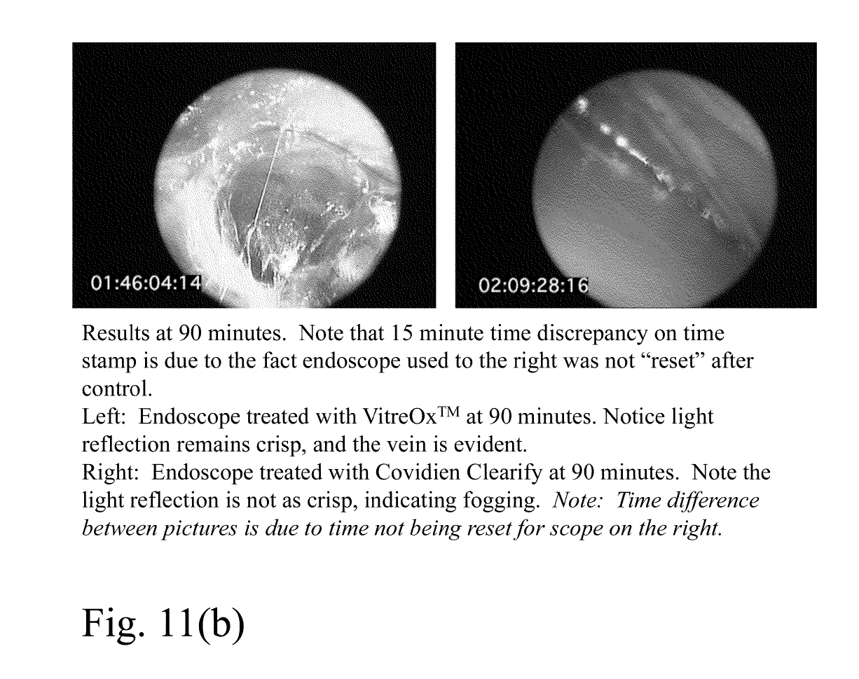

Representative depictions of lenses during the procedure are illustrated in FIG. 10 and FIG. 11. In FIG. 10, the left diagram is the control endoscope right before fogging. Light reflection on tissue remains crisp. The right diagram Control endoscope begins to fog. Notice light reflection is no longer crisp.

In FIG. 11b, the left diagram was extracted from a video of the endoscope treated with VitreOx™ at 90 minutes. Notice light reflection remains crisp, and the vein is evident.

In FIG. 11a, the right diagram was extracted from a video of the endoscope treated with Covidien Clearify at 90 minutes. Note the light reflection is not as crisp, indicating fogging. (Note: Time difference between pictures is due to time not being reset for scope on the right.)

### Results and Analyses

The results of the experiment fulfilled the desired objective of the experiment. As was postulated before the beginning of the experiment, the lens of the control (untreated) scope underwent significant fogging. The scope lens treated with Clearify® (first experimental group) had to be removed and reinserted at approximately 40 minutes into the process because of distortion on the image caused by fogging. Finally, the scope treated with VitreOx™ showed the best results: the clarity of the image was better as compared to the other test groups and also the scope didn't have to be removed and reinserted because VitreOx™ prevented the lens from fogging the entire 90-minute duration of the experiment. The only distinct phenomenon in this experiment was a small portion of the scope imaging becoming distorted, due to a dried lymph deposition, right before completing 90 minutes of surgery; which could be attributed to the higher amount of bodily fluids in pig A2 (no. 7023) that was exposed to the scope in the beginning of the experiment.

For the purposes of deciphering the results of this experiment, we analyzed the clarity of the image produced by the lenses of each scope (untreated, Clearify®-treated and VitreOx™ treated), and compared it to a chronological scale of the time spent inside the cavity. As time went on, whichever lens produced the clearest (least distorted/foggy) image was considered the best option.

### EXAMPLE II CONCLUSION

After analyzing the results of the experiment, treating the scope lenses with VitreOx™ produced the best and longest-lasting anti-fogging effect. Furthermore, the longer drying time of VitreOx™ made reapplication unnecessary in the 90 minute trial, and this will greatly reduce the frequency as well as save precious time in real-life medical situations.

Terms of degree such as “substantially”, “about” and “approximately” as used herein mean a reasonable amount of deviation of the modified term such that the end result is not significantly changed. These terms should be construed as including a deviation of at least ±5% of the modified term if this deviation would not negate the meaning of the word it modifies.

For purposes of this disclosure, the term “coupled” means the joining of two components (electrical or mechanical) directly or indirectly to one another. Such joining may be stationary in nature or movable in nature. Such joining may be achieved with the two components (electrical or mechanical) and any additional intermediate members being integrally defined as a single unitary body with one another or with the two components or the two components and any additional member being attached to one another. Such joining may be permanent in nature or alternatively may be removable or releasable in nature

The present disclosure has been described with reference to example embodiments, however workers skilled in the art will recognize that changes may be made in form and detail without departing from the spirit and scope of the invention. For example, although different example embodiments may have been described as including one or more features providing one or more benefits, it is contemplated that the described features may be interchanged with one another or alternatively be combined with one another in the described example embodiments or in other alternative embodiments. Because the technology of the present disclosure is relatively complex, not all changes in the technology are foreseeable. The present disclosure described with reference to the example is manifestly intended to be as broad as possible. For example, unless specifically otherwise noted a single particular element may also encompass a plurality of such particular elements.

It is also important to note that the construction and arrangement of the elements of the system as shown in the preferred and other exemplary embodiments is illustrative only. Although only a certain number of embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements shown as multiple parts may be integrally formed, the operation of the assemblies may be reversed or otherwise varied, the length or width of the structures and/or members or connectors or other elements of the system may be varied, the nature or number of adjustment or attachment positions provided between the elements may be varied. It should be noted that the elements and/or assemblies of the system may be constructed from any of a wide variety of materials that provide sufficient strength or durability. Accordingly, all such modifications are intended to be included within the scope of the present disclosure. Other substitutions, modifications, changes and omissions may be made in the design, operating conditions and arrangement of the preferred and other exemplary embodiments without departing from the spirit of the present subject matter.

While particular embodiments of the present invention have been shown and described, it will be obvious to those skilled in the art that changes and modifications can be made without departing from the embodiments of this invention in its broader aspects and, therefore, the appended claims are to encompass within their scope all such changes and modifications as fall within the true, intended, explained, disclose, and understood scope and spirit of this invention's multitudinous embodiments and alternative descriptions.

Additionally, various embodiments have been described above. For convenience's sake, combinations of aspects composing invention embodiments have been listed in such a way that one of ordinary skill in the art may read them exclusive of each other when they are not necessarily intended to be exclusive. But a recitation of an aspect for one embodiment is meant to disclose its use in all embodiments in which that aspect can be incorporated without undue experimentation. In like manner, a recitation of an aspect as composing part of an embodiment is a tacit recognition that a supplementary embodiment exists that specifically excludes that aspect. All patents, test procedures, and other documents cited in this specification are fully incorporated by reference to the extent that this material is consistent with this specification and for all jurisdictions in which such incorporation is permitted.

Moreover, some embodiments recite ranges. When this is done, it is meant to disclose the ranges as a range, and to disclose each and every point within the range, including end points. For those embodiments that disclose a specific value or condition for an aspect, supplementary embodiments exist that are otherwise identical, but that specifically exclude the value or the conditions for the aspect.

Finally, headings are for the convenience of the reader and do not alter the meaning or content of the disclosure or the scope of the claims.

What is claimed is:

1. A composition comprising a mixture of:
a solvated viscoelastic polymeric gel;
purified water;
and
metal- or metal-oxide-containing particles,
wherein the surface energy of the mixture is between 64-79 mJ/m2, 68-76 mJ/m2, 71-73 mJ/m2, or 72 mJ/m2.

2. The composition of claim 1 wherein
the solvated viscoelastic polymeric gel comprises a viscoelastic polymer having a molecular weight ranging from 20,000 to 4,000,000 Daltons;
the volume ratio of the viscoelastic gel to purified water is between about 1:1 and about 1:5;
the composition has a conductivity of less than about 250 μS/m;
and
the concentration of particles is 250-500 ppm, 1-10 ppm or 2-5 ppm.

3. The composition of claim 2 wherein particle size is sub-200 nm or is 1-3 nm size distribution.

4. The composition of claim 3 wherein the solvated viscoelastic polymeric gel comprises a viscoelastic polymer having a molecular weight of between about 20,000 Da and about 200,000 Da.

5. The composition of claim 4 wherein the purified water has a resistivity ranging from 0.5-2 MΩ-cm.

6. The composition of claim 5 wherein the solvated viscoelastic polymeric gel comprises a cellulose ester.

7. The composition of claim 6 wherein the particles comprise any one or any combination of Group 1, Group 2, transition, Group 3, or Group 13.

8. The composition of claim 7 wherein the particles comprise any one or any combination of Ag, Zn, Sn, Li, Na, K, Mg, Ca, Ti, Cr, Ni, Pd, Pt, Au, or Al.

9. The composition of claim 6 wherein the solvated viscoelastic polymeric gel comprises a cellulose

10. The composition of claim 9 wherein the particles comprise any one or any combination of Group 1, Group 2, transition, Group 3, or Group 13.

11. The composition of claim 10 wherein the particles comprise any one or any combination of Ag, Zn, Sn, Li, Na, K, Mg, Ca, Ti, Cr, Ni, Pd, Pt, Au, or Al.

12. The composition of claim 10 wherein the solvated viscoelastic polymeric gel comprises a glycosaminoglycan.

13. The composition of claim 12 wherein the particles comprise any one or any combination of Group 1, Group 2, transition, Group 3, or Group 13.

14. A device comprising:
a tubular body with a wall;
an open end adapted to receive an endoscope;
air-flow ports along the wall on the open end;
a delivery end including a syringe guide and a port adapted to lock to a syringe;
a transition between the open end and the delivery end, wherein the transition includes a conical dipping cup with an apex facing the delivery end and containing the port wherein the conical dipping cup is adapted to deliver a material to a lens of an endoscope.

15. The device of claim 14 wherein the transition further comprises a perforated plate disposed in the open end proximate the dipping cup.

16. A kit comprising:
a device comprising:
a tubular body with a wall;
an open end adapted to receive an endoscope;
air-flow ports along the wall on the open end;
a delivery end including a syringe guide and a port adapted to lock to a syringe;
a transition between the open end and the delivery end, wherein the transition includes a conical dipping cup with an apex facing the delivery end and containing the port wherein the conical dipping cup is adapted to deliver a material to a lens of an endoscope;
a syringe or syringe cartridge containing a material, where in the material is the composition of claim 1.

17. The kit of claim 16 wherein the material is the composition of claim 7.

18. The kit of claim 17 wherein the material is the composition of claim 8.

19. The kit of claim 18 wherein the material is the composition of claim 11.
